(19) United States
(12) Patent Application Publication
(10) Pub. No.: US 2018/0078819 A1
(43) Pub. Date: Mar. 22, 2018

(54) WEIGHT TRAINING AND MONITORING SYSTEM

(71) Applicant: FOXCONN INTERCONNECT TECHNOLOGY LIMITED, GRAND CAYMAN (KY)

(72) Inventors: CHANG-WEI KUO, NEW TAIPEI (TW); YI-CHUNG TENG, NEW TAIPEI (TW); JUI-KUANG CHUNG, NEW TAIPEI (TW); SU-NUNG CHAO, NEW TAIPEI (TW)

(21) Appl. No.: 15/708,053

(22) Filed: Sep. 18, 2017

(30) Foreign Application Priority Data
Sep. 18, 2016 (CN) 201621059392.X

(51) Int. Cl. A63B 24/00; G06Q 10/06

(52) U.S. Cl. CPC A63B 24/0062; A63B 2225/50; A63B 2024/0065; G06Q 10/06

(57) ABSTRACT

A monitoring/computing system for collecting and managing the data during weight-training, includes a supersonic sensor disposed upon the machine, and a data collection box communicating with the sensor for collecting the corresponding data which is successively transferred to the gateway for further analysis or use.

### BACKGROUND OF THE INVENTION

### 1. Field of the Invention

The present invention relates to a weight-training monitoring system.

### 2. Description of Related Art

Taiwan patent M433556 discloses the weight training device equipped with a sensing device having a magnetic pole cooperation with a magnetic matrix having sensors for monitoring. Anyhow, the sensing device is relative complicate and the monitoring effect is isolated which can not be efficiently managed.

### SUMMARY OF THE INVENTION

The invention is to provide an intelligent weight-training monitoring/computing system.

The monitoring/computing system for collecting and managing the data during weight-training, includes a supersonic sensor disposed upon the machine, and a data collection box communicating with the sensor for collecting the corresponding data which is successively transferred to the gateway for further analysis or use.

The supersonic sensor and the data collection box communicate with each other via either blue tooth or the USB wires, while the collection box communicates with the gateway via the blue tooth.

The system further includes a RFID (Radio Frequency Identification) system, a Wi-Fi wireless network station and a server system wherein the Wi-Fi wireless network station is connected with the server system, the RFID is connected to the Wi-Fi wireless network station and includes a tag and a card reader. The gateway is connected to the Wi-Fi-wireless network station via either the LAN (Local Area Network) or the WAN (Wide Area Network). The tag corresponds to the user while the reader corresponds to the machine.

The weight-training device includes a frame, weight blocks, a transmission device and an insertion pole to be selectively inserted into any weight block. The weight blocks are disposed in the frame and moveable in the vertical direction via the transmission device and the supersonic sensor senses the position of the insertion pole.

The supersonic sensor includes an emitting end and a receiving end and a fixing section. The insertion pole includes a reflection section and a selection section. The emitting end and the receiving end of the supersonic sensor face the reflection section of the insertion pole.

The weight blocks are stacked with one another in the vertical direction and each weight block includes an insertion hole for receiving the insertion pole.

The data collection box includes a power key, a Micro USB connection port, and a plurality of USB connection ports so as to connect to the sensor for data transmission.

The weight-training device includes the frame, the weight blocks, the transmission device and the insertion pole, and further includes a supersonic sensor to detect the position of the insertion pole instantly.

The communication between the supersonic sensor and the data collection box is made by either the blue tooth or the USB (Universal Serial Bus) wire.

Compared with the traditional weight-training device, in the invention the amount of the weight-training may be efficiently and instantly displayed to allow the user to view for easily understanding the depth of the exercise.

### BRIEF DESCRIPTION OF THE DRAWINGS

FIG. 1 is a flow chart of the weight-training monitoring system.

FIG. 2 is the partial flow chart of FIG. 1 when the user is approaching the weight-training device;

FIG. 3 is the partial flow chart of FIG. 1 during sensing the room circumstance;

FIG. 4 is the partial flow chart of FIG. 1 when the user is operating the weight-training device;

FIG. 5 is the perspective view of the weight-training device currently used by the user;

FIG. 6 is a perspective view of the supersonic sensor cooperating with the insertion pole inserted within the weight block of the weight-training device of FIG. 5;

FIG. 7 is a perspective view of the supersonic sensor cooperating with the insertion pole inserted within the weight block of the weight-training device of FIG. 5 wherein the weight blocks above the insertion pole are lifted up;

FIG. 8 is a side view of the supersonic sensor cooperating with the insertion pole inserted within the weight block of the weight-training device of FIG. 5 wherein the weight blocks above the insertion pole are lifted up;

FIG. 9 an exploded perspective view of the insertion pole of FIG. 6;

FIG. 10 is an assembled perspective view of the data collection box of the weight-training device of FIG. 5;

FIG. 11 is an exploded perspective view of the data collection box of the weight-training device of FIG. 10; and

FIG. 12 is another exploded perspective view of the data collection box of the weight-training device of FIG. 11

### DETAILED DESCRIPTION OF THE PREFERRED EMBODIMENT

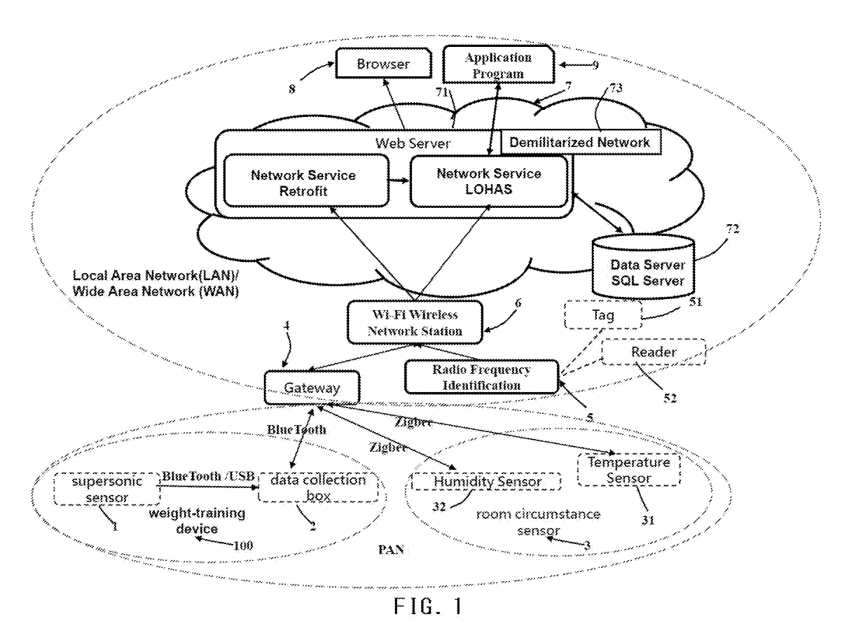

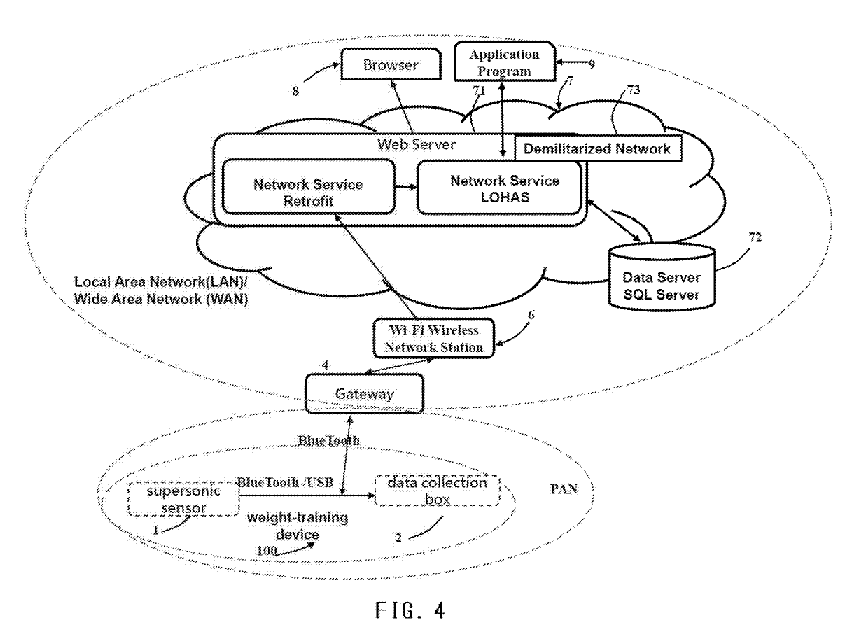

FIGS. 1-4 show the monitoring/computing system for use with the weight-training device 100 includes a supersonic sensor 1, a data collection box 2, a room circumstance sensor 3, a gateway 4, a RFID (Radio Frequency Identification) 5, a Wi-Fi wireless network station 6 and a server system 7.

In the weight-training monitoring/computing system, the gateway 4 communicates with the data collection box 2, the room circumstance sensor and the Wi-Fi wireless network station 6 for signal transmission therebetween.

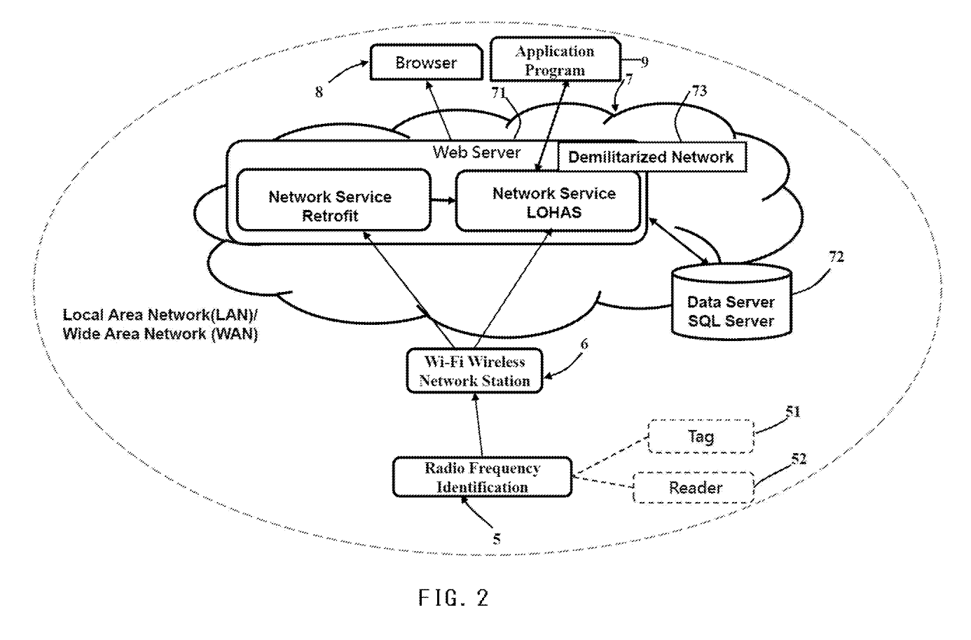

Referring to FIG. 2, the RFID 5 includes a tag 51 and a card reader 52 corresponding to the weight-training device 100. The RFID 5 transmits the data from the reader to the Wi-Fi wireless network station 6. Further referring to FIG. 1, the communication among the gateway 4, the RFID 5, the Wi-Fi wireless network station 6 and the server system 7 can be made via LAN or WAN. The server system 7 includes a web server 71 and a data server 72. The former contains information related the individual user and the data from the supersonic sensor and providing the browser service while the latter manages the data of all the users and all the machines. The server system 7 may provide partly the DMZ (Demilitarized Zone) or perimeter network 73 for limiting the approaching from the exterior to the enterprise server system for security consideration. The server system 7 may store all data of all the users and those of all the machines. The server system 7 may transmit the data derived from the users, the machines and the room circumstance sensor 3, to the browser 8 or the application program 9 of the mobile device.

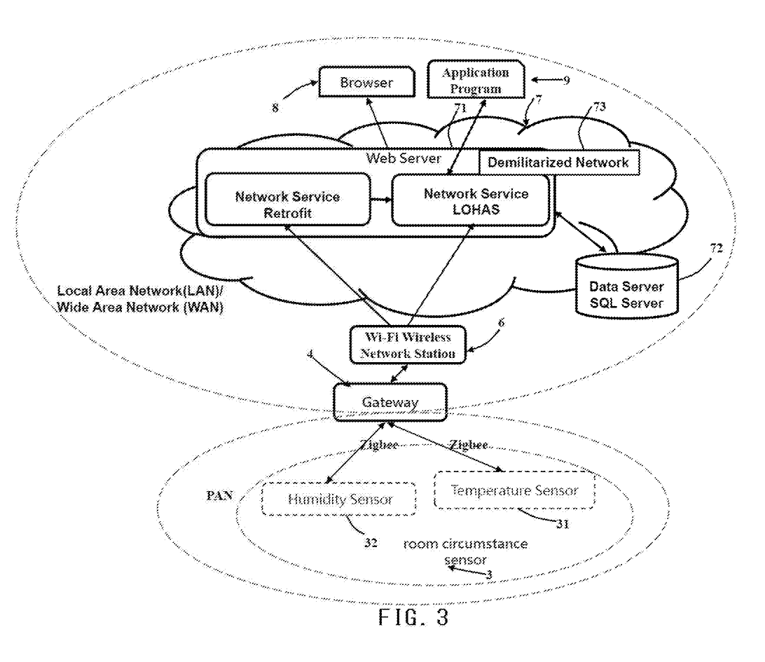

Referring to FIG. 3, the gateway 4 and the room circumstance sensor 3 communicate with each other via Low-Rate Wireless Personal Area Network (LR-WPAN), e. g., ZigBee. The room circumstance sensor 3 includes a temperature sensor 31 and a humidity sensor 32. The gateway 4 and the Wi-Fi wireless network station 6 communicate with each other via LAN or WAN. The WAN includes the Internet and the Wi-Fi wireless network station 6 includes a Wi-Fi module and the hot-spot or access point.

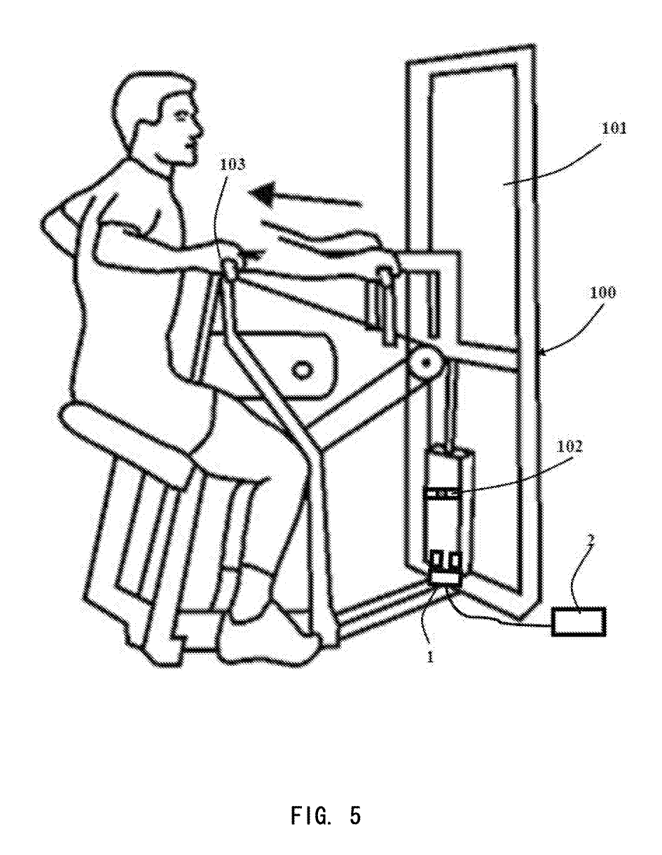

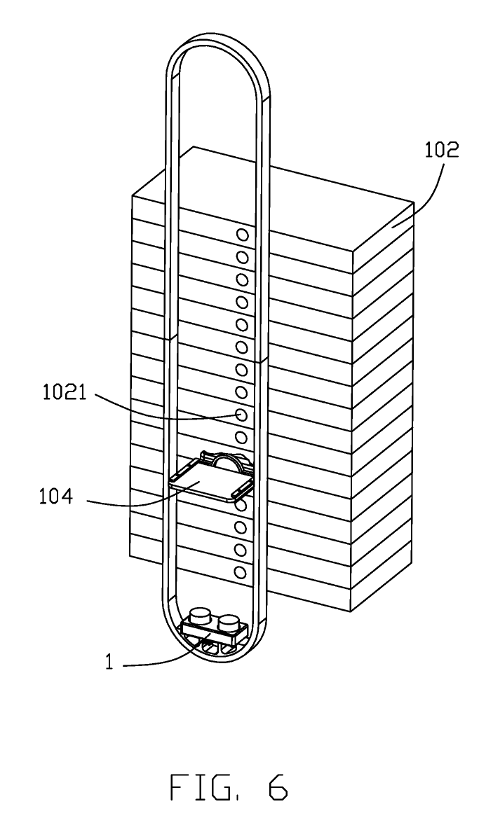

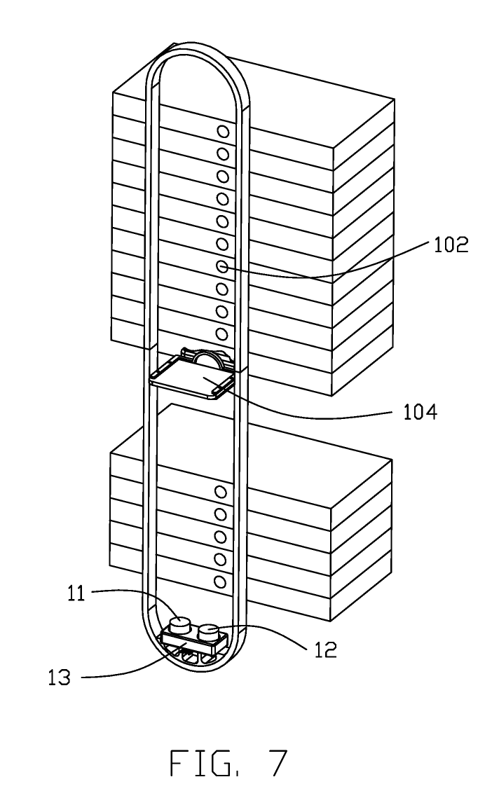

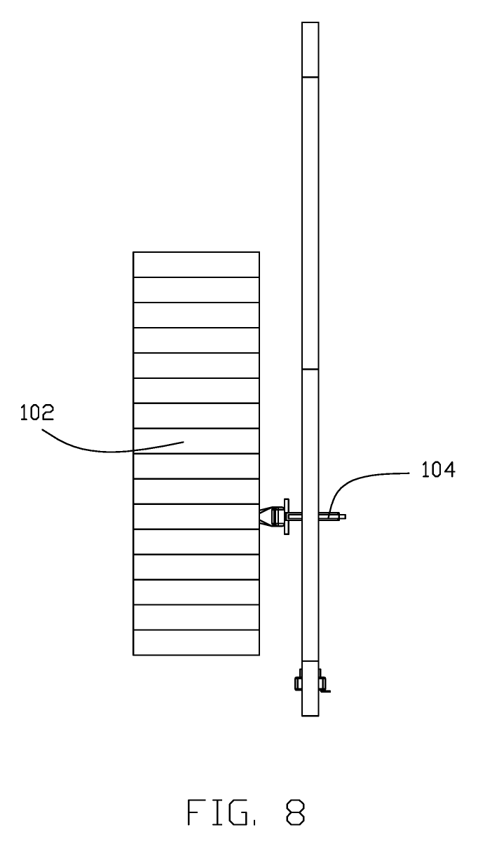

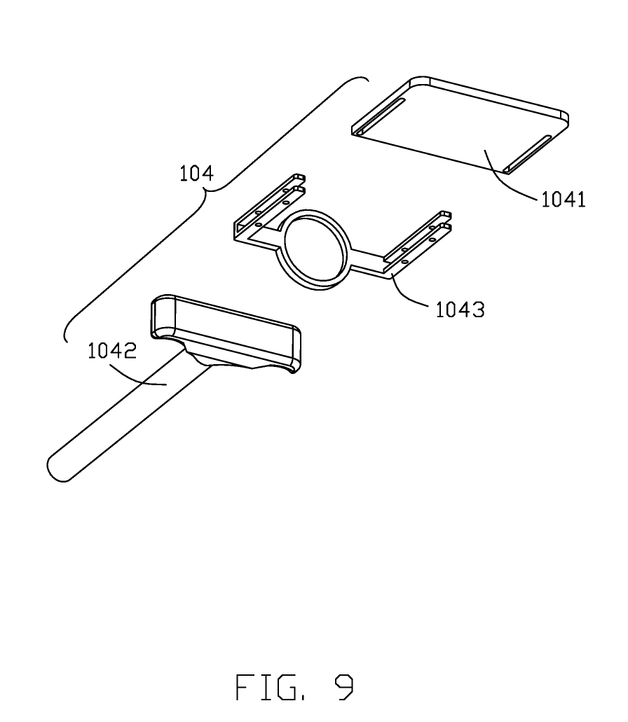

Referring to FIGS. 5-9, the weight-training device 100 includes a frame 101, the weight blocks 102. a transmission device 103, and the insertion pole 104 insertable into any weight block 102. The insertion pole 104 includes a reflection section 1041, a selection section 1042, and the connection section 1043 therebetween. The weight blocks 102 are stacked with one another vertically, and each weight block 102 includes an insertion hole 1021. The weight blocks 102 are disposed in the frame 101 and activated by the transmission device 103 and moveable vertically.

The supersonic sensor 1 is mounted upon the frame 101 and below the weight blocks 102 and aligned under the insertion pole 104. The supersonic sensor 1 includes an emitting end 11, a receiving end 12 and a fixing part 13. The supersonic wave emitted from the emitting end 11 of the sensor 1 hits the reflection section 1041 and is reflected to the receiving end 12 to activate the signal. The time difference between the emitting end 11 and the receiving end 12 may correspond to the distance between the insertion pole 104 and the sensor 1. During weight lifting, the selected weight block 102 where the insertion pole 104 is selected, is moved to the uppermost position, the distance increases and corresponds to the amount of the weight which has been raised.

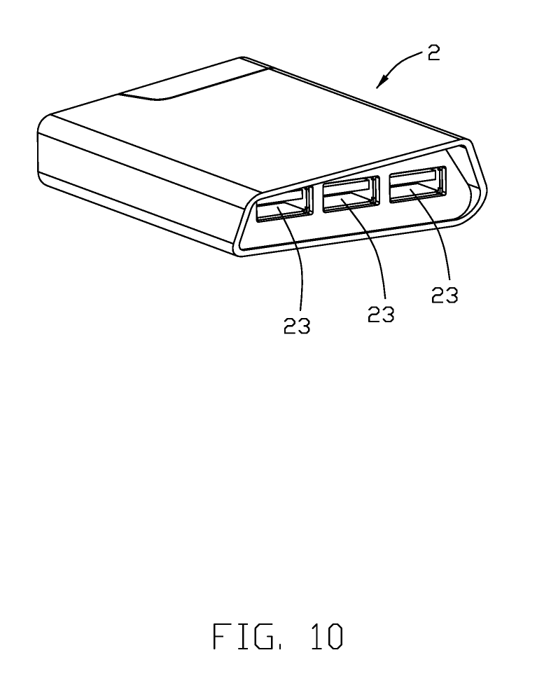

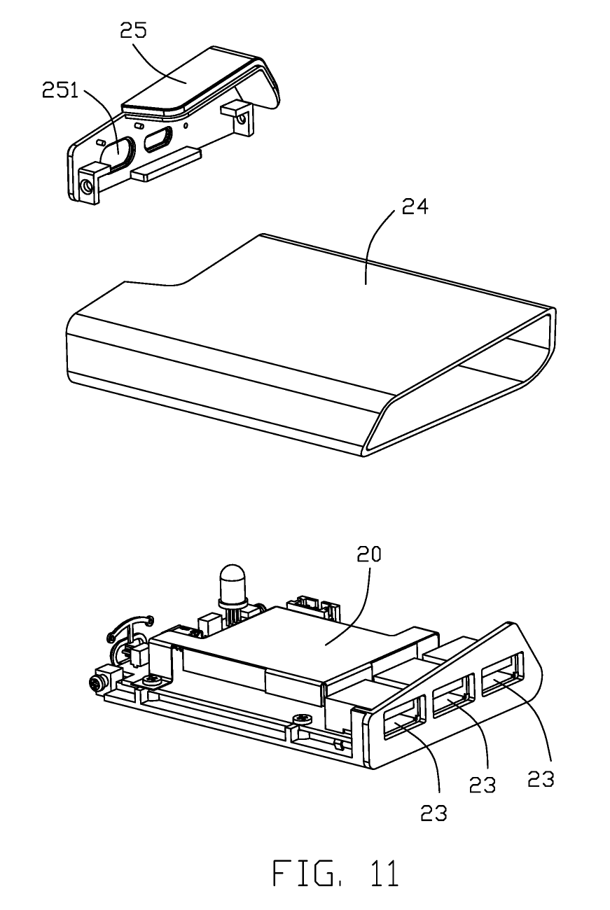

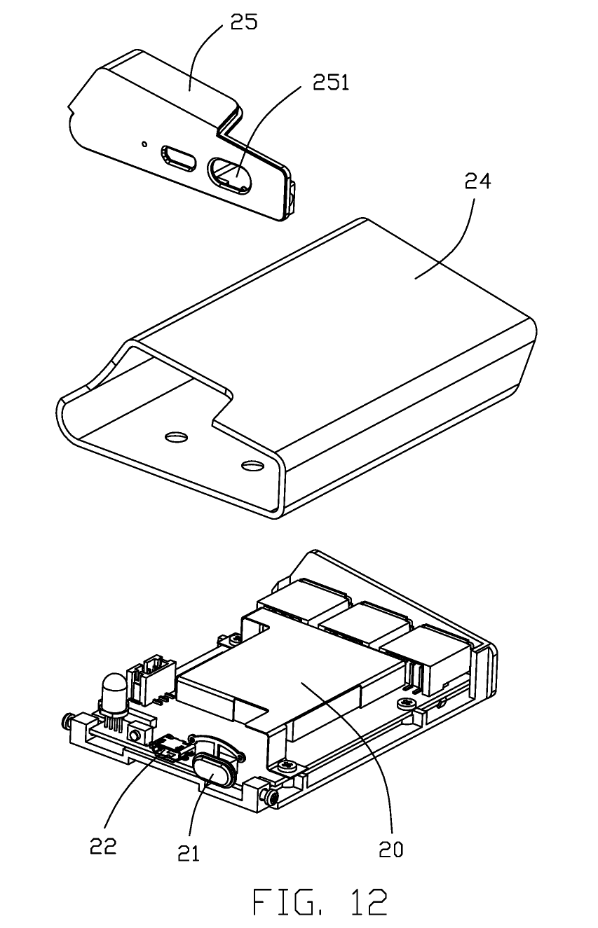

Referring to FIGS. 10-12, the data collection box 2 can be located on the front side of the treadmill and includes on one side a power key 21 for on/off usage, a Micro USB connection port 22, and on the other side three USB connection ports 83 for collecting the data from the sensors 1. The sensor 1 is disposed upon the device 100 and connected, via the blue tooth or the USB wire, to the data collection box 2 which further transfers the data derived from the sensor 1 to the gateway 4 via the blue tooth. Notably, other transmission way such as Wi-Fi is possible. The data collection box 2 further includes a printed circuit board assembly (PCBA) 20, an external shell 24 to cover the printed circuit board assembly 80, and a cover 25 upon one side of the external shell 24. The PCBA 20 may manage the data, the power key 21 and the Micro USB connection port 22 are located by one side of the PCBA 80, the cover 25 forms the opening 251 to expose the power key 21 and the Micro USB 22, while the USB connection ports 23 are located by the other side of the PCBA 80. Understandably, the sensor 1 may be connected to the data collection box 2 via WPAN, e.g., the blue tooth.

The server system 71 may manage the setting of the weight block 102. For example, the effective lift-up distance for different number weight blocks varies and could be measured for assuring the user's action is complete.

The process of the weight-training is as follows. The user have his own tag 51 directed to the reader 52 so the RFID 5 sends the signal/data to the Wi-Fi wireless network station 6. The Wi-Fi wireless network station 6 sends the data to the server system 7 to have the web server 71 compare the data with that stored in the data server 72 and allow the user or the manager view the results via the browser or the App. When the user is lifting the weight blocks, the sensor 1 senses the insertion pole 104 to compute the effective amount and times the user performs and send the data to the data collection box 2. The data collection box 2 sends the user's exercise data and those derived from the room circumstance sensor 3 to the gateway 4. The gateway 4 sends the data to the Wi-Fi wireless network station 6 which further sends the data to the server system 7 via LAN or WAN. The server system 7 analyzes the data related the user, the device 100 and the room circumstance sensor 3. The server system 7 further manages the data to be displayed by the browser 8 or the App 9 viewable by the user and the manager or the coach.

The weight-training device and the corresponding monitoring/computing system may not identify the user for using the device but also efficiently watching the degree or the depth of the training and instantly reflecting the results.

In conclusion, the data collection box 2 may collect the related data from the sensors 1 via either the wires or the blue tooth and further transfer the computed data to the gateway 4. The invention also uses the gateway 4 to integrate the data from the data collection box 2 and the room circumstance sensor 3 via the blue tooth or ZigBee, which are under the different protocols, together. The Wi-Fi wireless network station 6 also collects the personal data via RFID 5 and the computed data from the gateway 4 to the server system 7 for efficient management.

However, the disclosure is illustrative only, changes may be made in detail, especially in matter of shape, size, and arrangement of sections within the principles of the invention.

What is claimed is:

1. An intelligent sensing and computing system for use with a weight-training device, comprising:
a gateway and an RFID (Radio Frequency Identification) commonly connected to a Wi-Fi wireless network station;
a server system connected to the Wi-Fi wireless network station;
a data collection box connected to the gateway; and
sensors for sensing an amount of weight and connected to the data collection box.
